(19) United States
(12) Patent Application Publication
(10) Pub. No.: US 2022/0358419 A1
(43) Pub. Date: Nov. 10, 2022

(54) System and Method for Accommodations Approval

(71) Applicant: ReloQuest, Inc., Sunrise, FL (US)

(72) Inventor: Darin F. Karp, Sunrise, FL (US)

(21) Appl. No.: 17/388,323

(22) Filed: Jul. 29, 2021

Related U.S. Application Data
(63) Continuation-in-part of application No. 16/777,029, filed on Jan. 30, 2020, now abandoned.
(60) Provisional application No. 62/799,284, filed on Jan. 31, 2019.

(51) Int. Cl. G06Q 10/02; G06Q 50/12; G06Q 30/02; G06F 16/22

(52) U.S. Cl. CPC G06Q 10/02; G06Q 50/12; G06Q 30/0206; G06F 16/2272

(57) ABSTRACT

Disclosed is a system and method for allowing an organization to manage and approve requests for accommodations. The system is advantageously used, for example, by employees within an organization who may be making work related travel plans. The system allows the organization to approve and keep track of such travel, while also ensuring that the accommodations being booked are consistent with company policies, previously received RFPs, and prevailing market rates.

### CROSS REFERENCE TO RELATED APPLICATIONS

This application claims priority to co-pending Utility patent application Ser. No. 16/777,029, filed on Jan. 30, 2020, entitled “Method for Determining Rate Compliance,” which in turn claims priority to Provisional Patent Application Ser. No. 62/799,284, filed on Jan. 31, 2019, entitled “Method for Determining Rate Compliance.” The contents of both these applications are fully incorporated herein for all purposes.

### BACKGROUND OF THE INVENTION

### Field of the Invention

This invention relates to a method for verifying compliance with a stated rate. More specifically, the method allows customers seeking housing accommodations to verify, in real time, whether quoted rates comply with previously stated rates. The invention further relates to a system and method for accommodations approval.

### Description of the Background Art

The process of providing reliable accommodations to institutions, such as corporate housing, can be complex. It involves the relationship between requestors, on the one hand, and suppliers on the other. Requestors can be any customers, clients, or individuals who are searching for, or in need of, housing accommodations. Suppliers can be vendors, providers, companies, or individuals that provide housing accommodations and related services. Suppliers can also be companies that sublet from apartment communities. For example, the requestor could be a large Fortune 500 company seeking housing for its executives for the month of April in downtown Atlanta, and the supplier could be the owner of various apartment complexes or condominiums around the country seeking to provide such accommodations.

Often times, the supplier is chosen by the requestor on the basis of a request for proposal (“RFP”). Suppliers respond to RFPs by providing various rate information. This rate information may be broken down or indexed on the basis of the: requested geographic location (i.e. city, state, country); desired dates and length of stay; and the size or configuration of the accommodation (i.e. bedroom size). Once an RFP is awarded, requestors expect that the suppliers will subsequently provide pricing consistent with the RFP. Problems arise, however, when the supplier subsequently specifies rates that are different from those quoted in the RFP. For this reason, RFP's often cause accounting problems for both requestors and suppliers alike. Requestors simply lack the processes necessary for validating the pricing previously quoted by suppliers in an RFP. The present method is designed to overcome these and other shortcomings present in the art.

### SUMMARY OF THE INVENTION

The present method provides a means of determining compliance with stated rates; more specifically, the method determines if specified rates for housing accommodations are higher or lower than those quoted in an RFP.

One of the objects of this method is to permit a requestor to determine if a specified rate complies with previously quoted rates.

Another object of this method is to allow a requestor to specify the parameters under which a specified rate will be deemed acceptable.

Another object of this method is to allow different rates for housing accommodations to be easily comparted on the basis of various indexed factors, such as geographic location (i.e. city, state, country); desired dates and length of stay; and the size or configuration of the accommodation (i.e. bedroom size).

These and other objectives are satisfied by providing a method for automating the RFP process and providing real time compliance and validation (as well as other metrics) at a point prior to the transaction being completed. This allows clients/consumers to make the best purchasing decisions when booking corporate housing. In accordance with the method, once an RFP is completed and the supplier is selected, the supplier's quoted pricing from the RFP is uploaded into the platform, so that at the time of any booking, requestors will have real time access to the previously agreed RFP pricing. This allows subsequently specified rates to be flagged as being either in or out of compliance with the quotes identified in the RFP. This empowers requestors to make the best purchasing decision prior to booking a corporate accommodation.

The present method also provides various workflows to assist buying decisions that fall outside of the compliance. Depending on configurations selected, an individual may require authorization from another supervisory user prior to a transaction being completed. These supervisory users will be notified in the process for their approvals prior to the booking. The result is a painless RFP process for both requestor and suppliers alike. Furthermore, real time reporting, supplier performance, and cost containment will provide all departments of the requestor (e.g. HR, procurement, supply chain, etc.) valuable insights into the RFP process on a real time basis.

Also described is a system and method for approving a request for accommodations within an organization. The system and method allow an organization to manage expenses associated with employee travel and ensures that hotel rooms are being booked in a manner that is consistent with pre-established company policies.

The method for accommodations approval allows an employee to query a database of available accommodations. The employee is then presented with a graphical display of available accommodations. A processor then compares the identified rates and room types to ensure that they are consistent with company policies. The employee will be prompted to seek a supervisor's approval before booking an accommodation that is not in keeping with the policy.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a flow chart illustrating the initial steps of the present method.

FIG. 2 is a flow chart illustrating additional steps of the present method.

FIG. 3 is a flow chart depicting a workflow wherein an administrator uploads rates received from a supplier company.

FIG. 4 is a flow chart depicted a workflow wherein a supplier submits various options.

FIG. 5 is a flow chart wherein a requestor reviews various options (enterprise application).

FIG. 6 is a flow chart wherein a requestor review various options (B2E application).

FIGS. 7-18 are various screen shots from the program implementing the method of the present disclosure.

FIG. 19 is a flow chart depicting the steps involved in the accommodations approval process.

FIG. 20 is a screen shot of available accommodations as presented to an employee.

FIG. 21 is a screen shot illustrating the interface used to request an accommodations approval.

FIG. 22 is a screen shot illustrating the accommodations approval dashboard as presented to a supervisor.

Similar reference characters refer to similar parts throughout the several views of the drawings.

### DETAILED DESCRIPTION OF THE PREFERRED EMBODIMENT

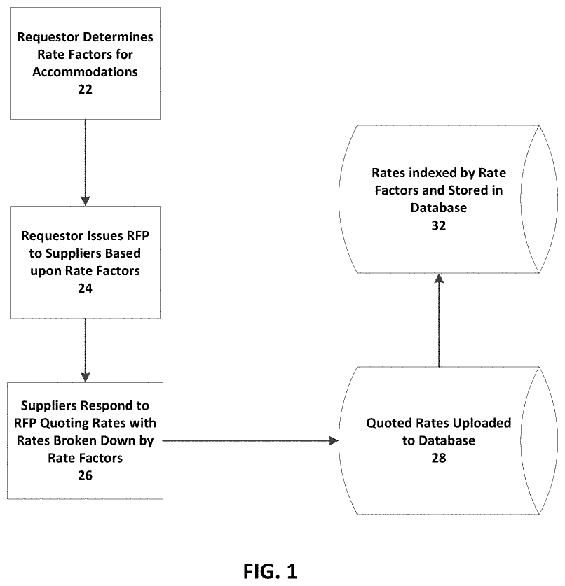

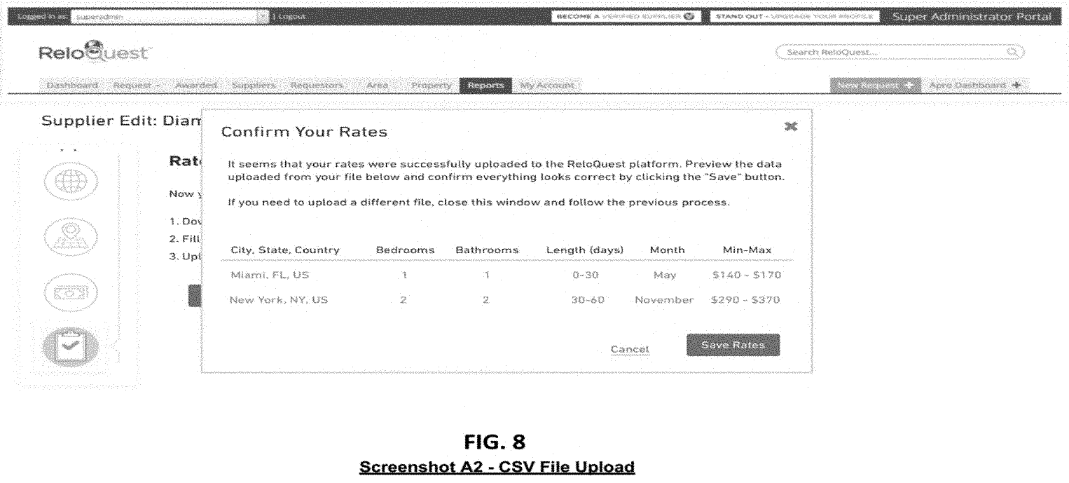

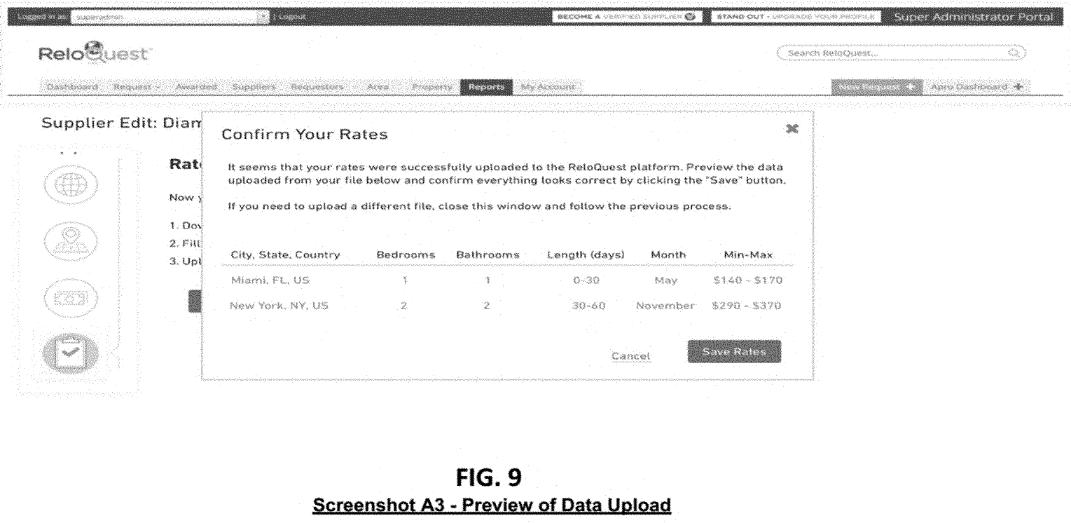

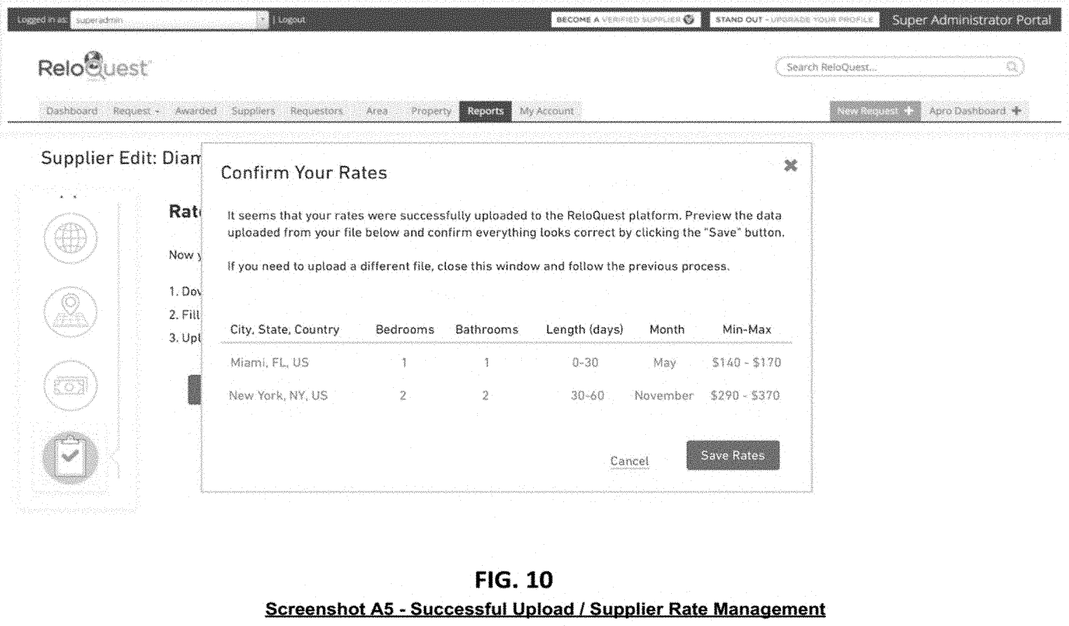

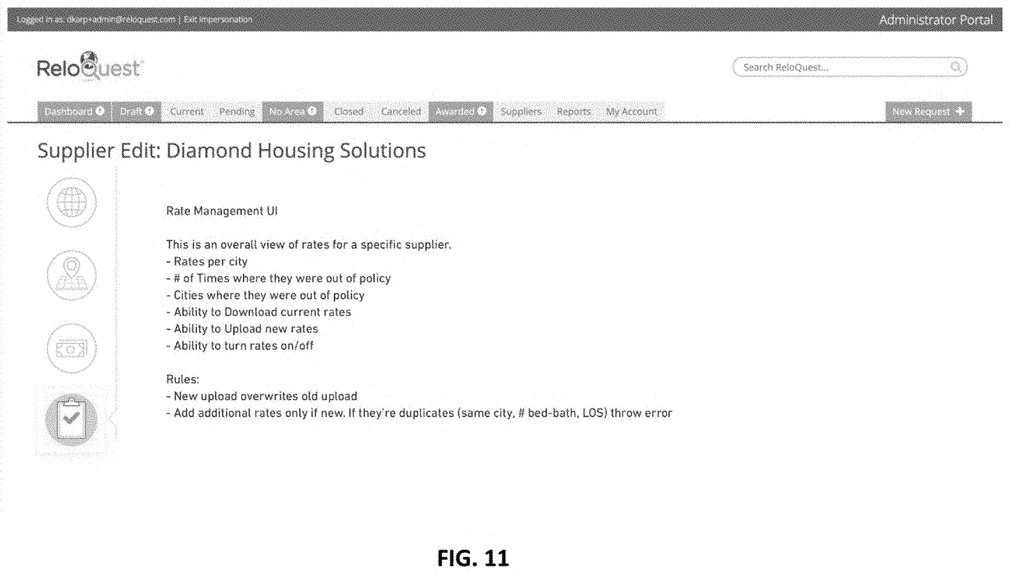

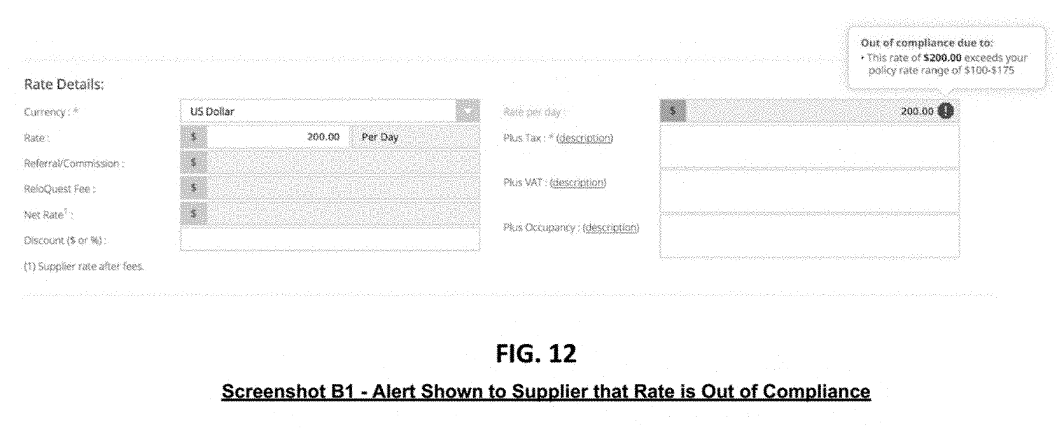

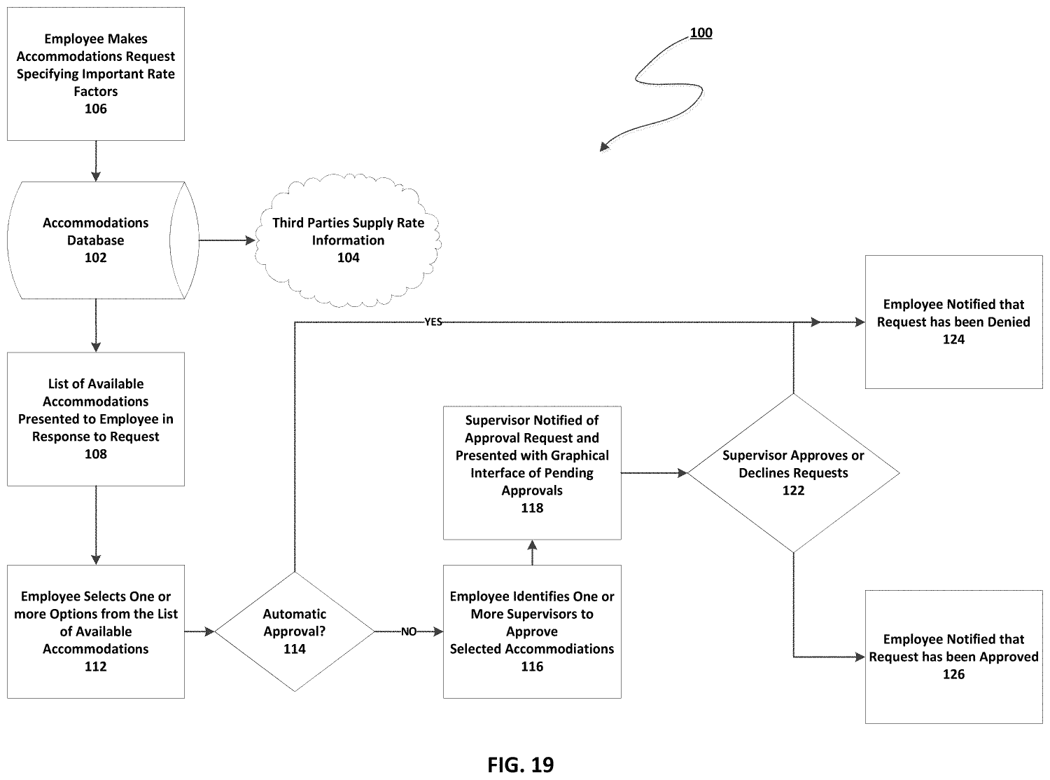

The present disclosure relates both a method for determining rate compliance as well as a method for approving an accommodations request. Both methods can be employed within an organization for managing costs associated with employee travel and accommodations. The method for rate compliance is described in connection with FIGS. 1-18 and the method for approving accommodations requests in described in connection with FIGS. 19-22. The various aspects of the present invention are described in greater detail hereinafter.

### Method for Determining Rate Compliance

The present disclosure relates to a method for determining rate compliance. This aspect of the invention is depicted in FIGS. 1-18. The method automates the request for proposal (“RFP”) process related to corporate housing or accommodations. It is intended for use by both requestors (customers/individuals searching for housing) and suppliers (vendors/providers of housing and related services). The goal of the system is to provide real time compliance and validation at a point prior to a transaction being completed. In this manner, the prices quoted by a supplier can be compared to previously agreed pricing.

In accordance with the method, a requestor issues an RFP to a variety of suppliers. As used herein, a requestor is a company or individual who is searching for, or in need of, housing accommodations. These accommodations are periodically needed over a period of time and often for employees of the requestor. The accommodations may be needed for specific areas of the country and for prolonged durations. The requestor may have certain criterion for the size or features of the housing. By way of non-limiting example, the requestor could be a large Fortune 500 company seeking to house a number of executives in downtown Atlanta for the month of April. The executives may require multiple bedrooms, a kitchen, and access to a gym. As used herein, suppliers are companies or individuals that provide housing accommodations and related services. The related services may be housekeeping or workout facilities. By way of non-limiting example, the supplier could be the owner of various apartment complexes or condominiums around the country.

The RFP issued by the requestor will seek, inter alia, rate information related to the housing accommodations. One or more suppliers will respond to the RFP by providing various rate information. One the basis of this rate information, an RFP will be awarded. The rates identified by the supplier are often broken down on the basis of various rate factors, including but not limited to: geographic locations (i.e. city, state, country); desired dates; length of stay; the size or configuration of the accommodation (i.e. bedroom size); and the availability of ancillary services (housekeeping, workout facilities, laundry etc.).

In accordance with the invention, the supplier or requestor may enlist the services of a third party to implement the disclosed method. However, it is within the scope of the present disclosure for the supplier or requestor to themselves implement the disclosed method. An RFP response with identified rate information can be uploaded into a databased maintained by the third party. This step may be carried out by the requestor. The uploaded RFP response is scanned so that the rate information can be extracted. The third party then indexes the extracted rate information on the basis of the various rate factors noted above. The indexed rates are correlated to a particular supplier. The indexed and correlated rates are stored as a matrix in the database for future reference (hereinafter the “stored rates”).

A requestor may thereafter conduct a search in connection with the need for accommodations on specific dates and a specific location. Various suppliers will provide “specified rate” information in response such as a search. In accordance with the method, the third party will be given access to the specified rate information so that it can be indexed on the basis of the identified rate factors. The specified rates are thereafter compared to the stored rates. In this regard, both the specified rates and the stored rates are similarly indexed so that they can be effectively compared to one another. The requestor is alerted if the specified rates are not in compliance with the rates identified by the applicable supplier in response to the RFP. For example, a red flag may alert a requestor if the specified rate is greater than the stored rates. A yellow flag may indicate that there is no stored rate that correlates with the specified rate. This may occur if no RFP is in place. The absence of any flag may indicate that the specified rate is in compliance with the stored rate.

The method also contemplates controls for allowing a supervising employee of the requestor to tailor the alerts provided by the system. For example, a red flag may be generated only if the specified rate deviates by a certain percentage over the stored rate. Namely, the red flag may be generated if the specified rate is 5% or more above the stored rate. A green flag may be generated if the specified rate is below the stored rate. Any number of controls can be provided based upon the particular auditing objective of the requestor. The present method can likewise be employed by suppliers to ensure that a rate is within compliance prior to it be specified.

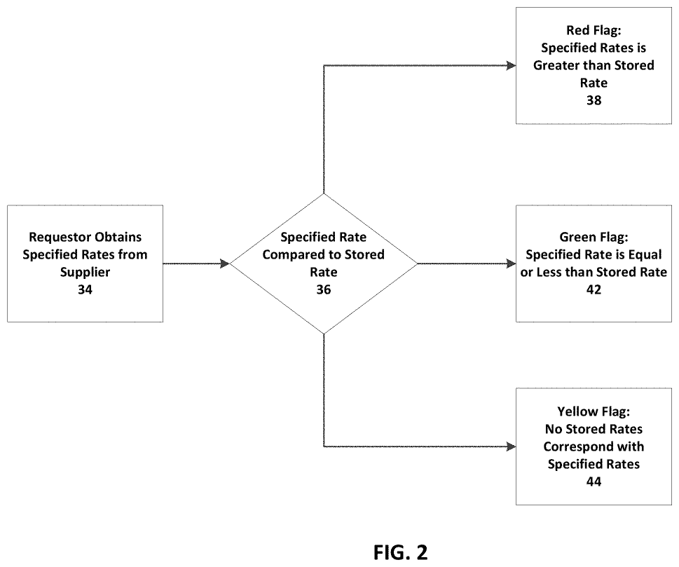

The basic steps of the present method are illustrated in FIGS. 1 and 2. The method allows a requestor to determine whether a specified rate for accommodations is in compliance with a previously quoted rate by a supplier. As illustrated in FIG. 1, at step 22 the requestor specifies various rate factors that may impact a quoted rate. These rate factors may include dates of the stay, geographic location, and the type of accommodation being requested. Next, at step 24, the requestor issues a request for proposal (“RFP”) to one or more suppliers. The RFP is based upon the rate factors. Namely, the RFP will specify, inter alia, dates of stay, geographic location, and the type of accommodations being sought. At step 26, one or more suppliers responds to the RFP by providing quoted rates. The quoted rates are ideally broken down by the rate factors. Namely, different rates may be specified for different dates, different geographic locations, and different accommodation types. At step 28, the quoted rates are uploaded and stored into a database. At step 32, which can be carried out before or after the rates are uploaded, the stored rates are indexed in accordance with the rate factors.

As illustrated in FIG. 2, at step 34, a specified rate is thereafter obtained from a supplier. This may be for a specific date, location, and accommodation. At step 34, this specified rate is compared to the quoted rate as stored in the database (i.e. the “stored rate”). As a result of this comparison, the determination is made whether the specified rate is greater than (38) or less than (42) the stored rate. If no corresponding stored rates can be found, that is indicated at step 44.

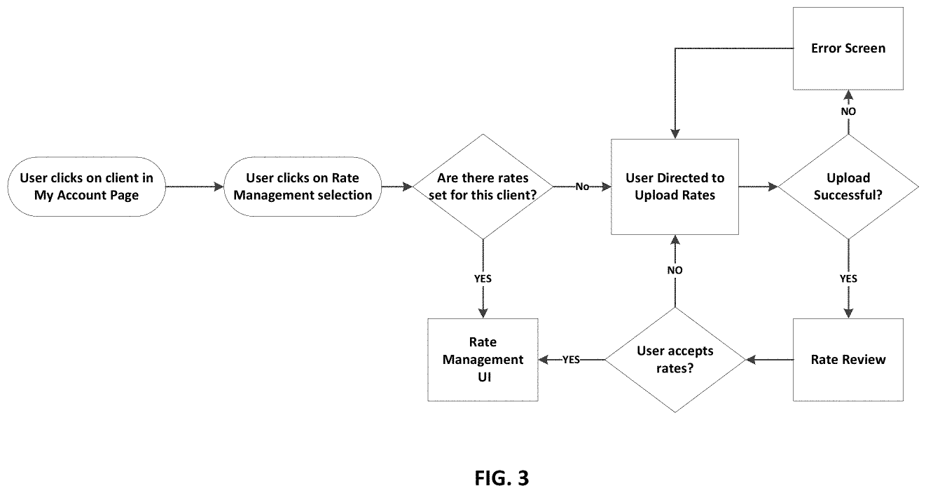

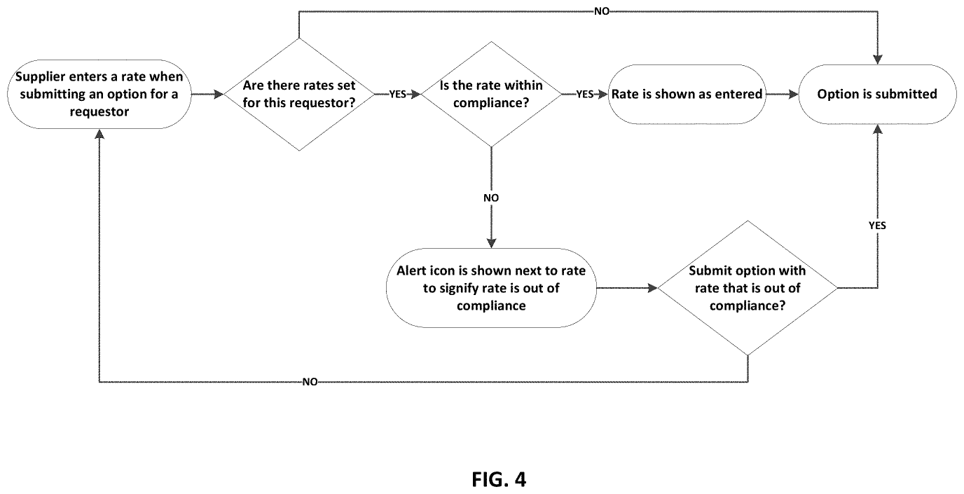

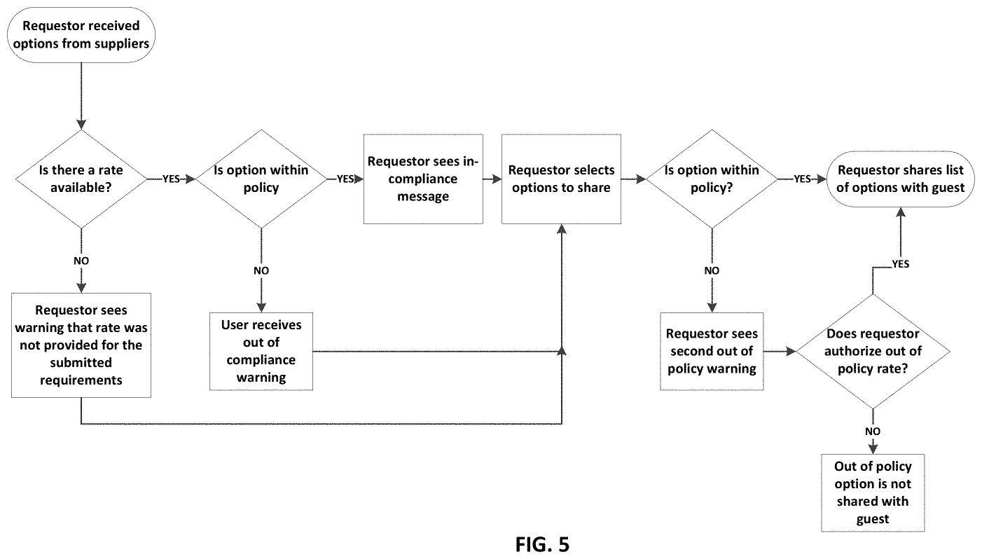

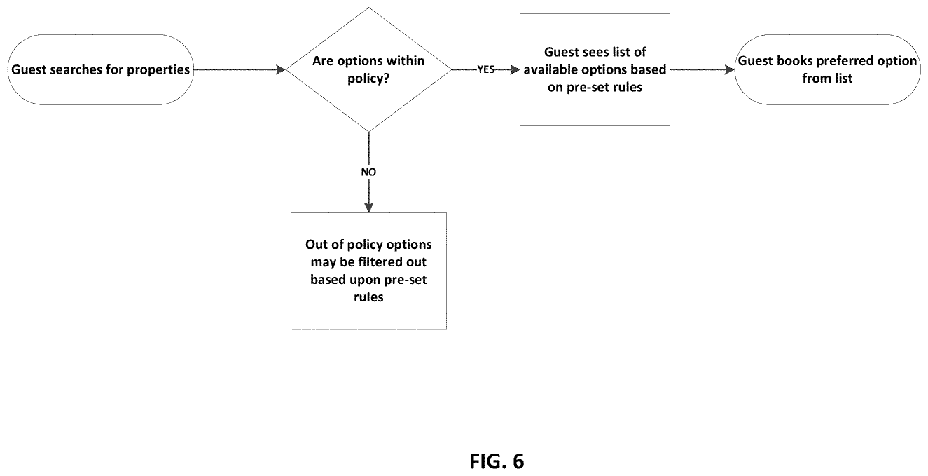

Various workflows are depicted in the associated Figures. For example, FIG. 3 illustrates “Workflow A,” which involves and administrator uploading rates received from a supplier. This involves selecting the vendors/suppliers the client will use. The administrator can upload the agreed upon pricing schedule directly into the platform. Workflow B is depicted in FIG. 4 and involves a supplier submitting various options. Workflow C is depicted in FIGS. 5 and 6 and involves requestor reviewing options. FIG. 5 illustrates this workflow in connection with enterprise level entity and FIG. 6 illustrates the workflow on a business-to-employee (“B2E”) level.

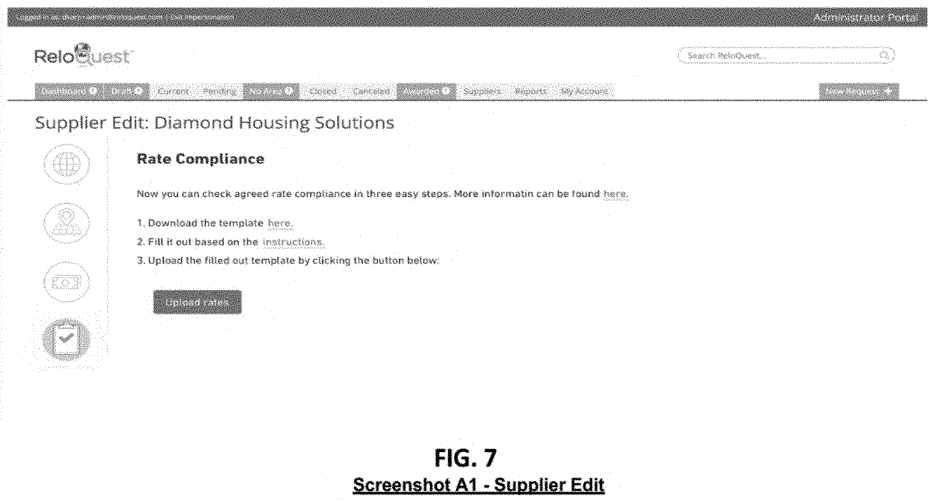

Various screenshots associated with the A, B, and C workflows are provided as FIGS. 7-13.

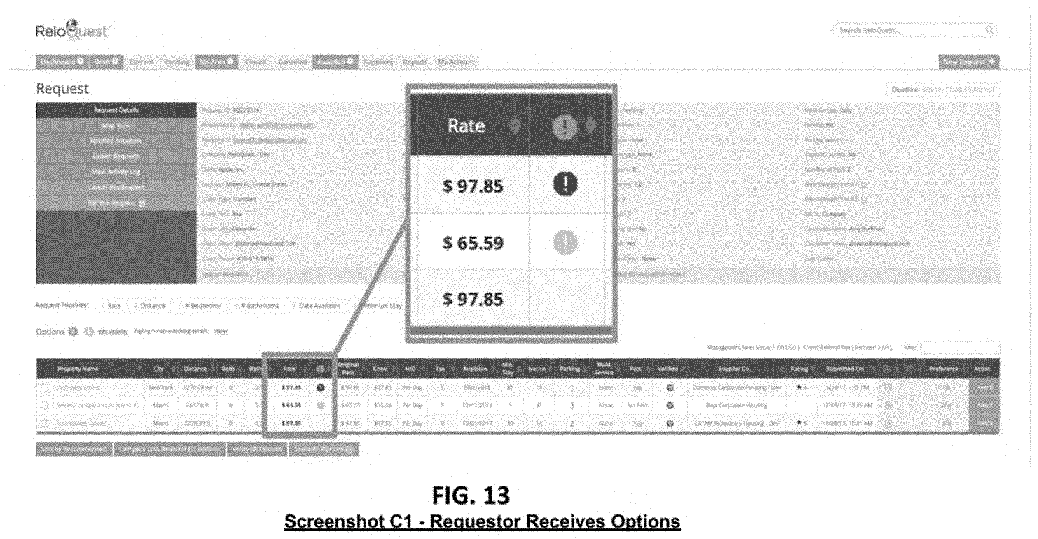

After an RFP, the normal day to day operations take place. Requests are entered into the system and options are displayed for the requestor users. FIG. 13 shows how a requestor user received options for the request details at the top. These users can be employees, HR managers, relocation managers or consultants. They can review options provided on an actual request and in real time compare them to what the contracted rates are supposed to be from those suppliers (RFP rates). Making decision making that much easier and correct, providing cost saving results in real time. Reports can be run using this data to show how often suppliers are in compliance, what areas, and for other parameters. B2E platforms (self-service) can also be provided where employees can use the same parameters. Rules can be created to allow employees to see or hide options out of compliance or out of compliance by a certain $ or %.

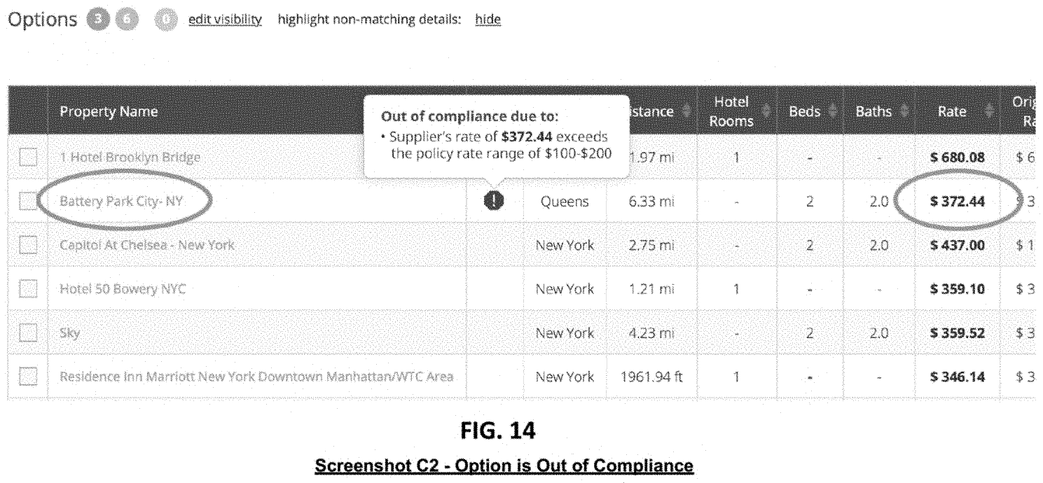

If the option is out of compliance it is flagged in red as noted in FIG. 14. The user can still award or share options. Rules can also be created so that the requestor user can or cannot see out of compliance options, or out of compliance options based on $ or % difference.

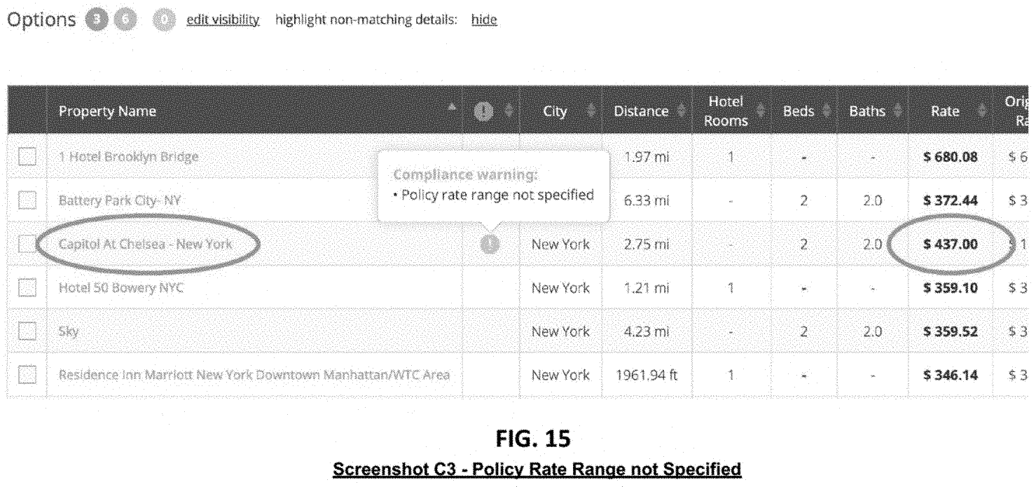

If supplier/vendor did not have pricing for this location it would display a yellow warning for the user (FIG. 15), notifying them there is no data to support an in/out of compliance. Rules can be set to show or hide these options.

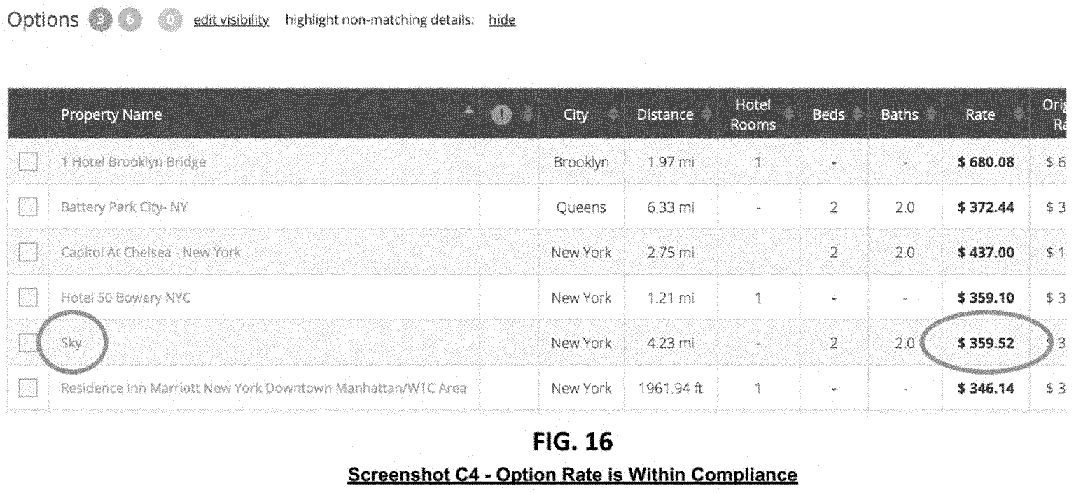

If a rate is within compliance, there is no Icons displaying, letting the user know the options fall within compliance (FIG. 16).

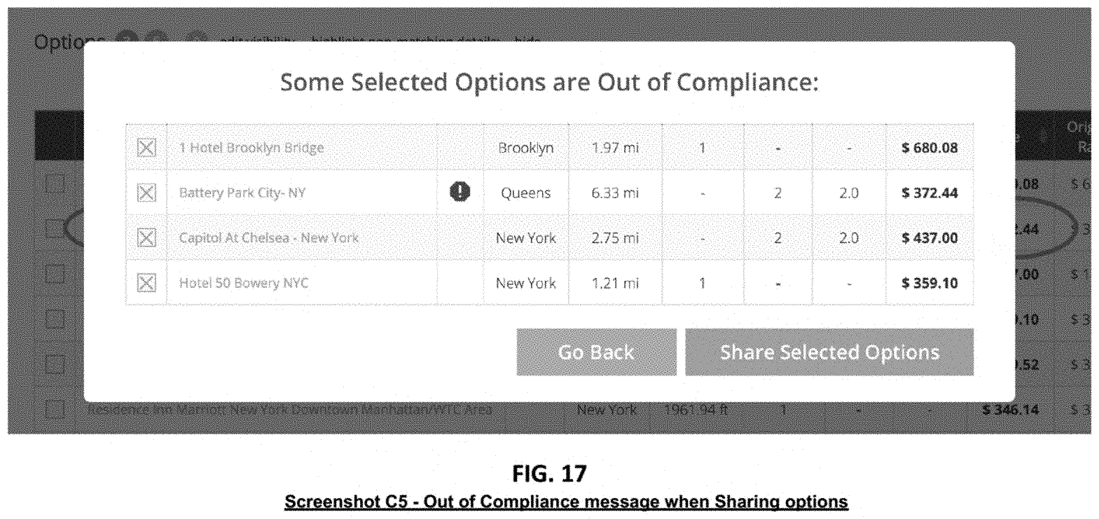

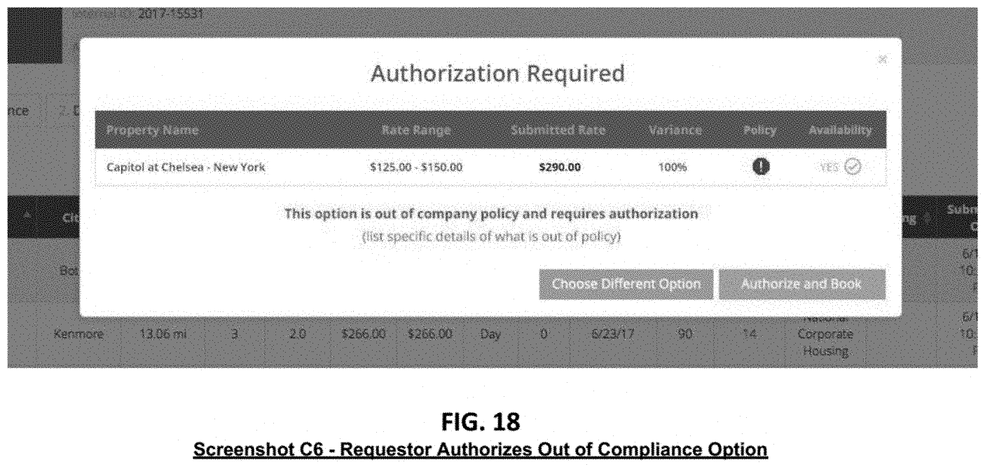

If the Config is set to requiring authorization for out of compliance options, the requestor could authorize it or select another option to share or book. If the employee was doing this through a B2E (business-to-employee) self-service platform, they would have a button to share it with the authorized user (FIG. 17) who can make the decision on approving the option or not (FIG. 18).

Various reports can be generated in connection with the system to show the frequency and degree with which specified rates are in compliance. Being able to capture all different types of metrics is now within a few clicks of a button.

### System and Method for Accommodations Approval

The present disclosure also relates to a system and method for allowing an organization to manage and approve requests for accommodations. This aspect of the invention is depicted in FIGS. 19-22. The system 100 is depicted in the flow chart of FIG. 19 and is advantageously used, for example, by employees within an organization who may be making work related travel plans. System 100 allows the organization to approve and keep track of such travel, while also ensuring that the accommodations being booked are consistent with company policies, previously received RFPs, and prevailing market rates.

As illustrated in FIG. 19, a key part of system 100 is an accommodations data base 102 containing a catalog or inventory of available properties. This may be a variety of different types of accommodations, such as hotels, motels, resorts, houses, town homes, and apartments. The term “accommodation” as used herein is intended to be inclusive of any type of temporary or short term housing. The stored accommodations are indexed within database 102 according to various price factors. These price factors can include, but are not limited to, geographic location, room size, room type, amenities, nearby landmarks, and desired reservation dates. Database 102 may communicate with remote third party providers 104, via the Internet, to periodically update the catalog of available accommodations.

Accommodations database 102 may, for example, be available to members of an organization over a private network or LAN. The organization may be a company with the database 102 being securely accessed only by employees and supervisors within the company. In this instance, an employee would be given secure access to database 102 for the purpose of making queries for work related travel. The employee may, for example, be looking for a hotel room for an overnight business meeting. The employee could also be looking to rent a house or apartment for several weeks for a long term project. In any event, the employee queries the database at 106. In making this query, the employee would specify various rate factors, such as dates, duration, desired room types, location, etc. The employee may also be prompted to specify which of the factors are the most important for the trip. The factors may also be ranked by the employee. For example, for a particular business trip, it may be very important that the accommodation be located within a given distance of a landmark. Alternatively, in certain circumstances, location may be less important than the specific dates of the stay. If the employee is hosting people during the meeting, having access to multiple rooms may be a highly ranked factor.

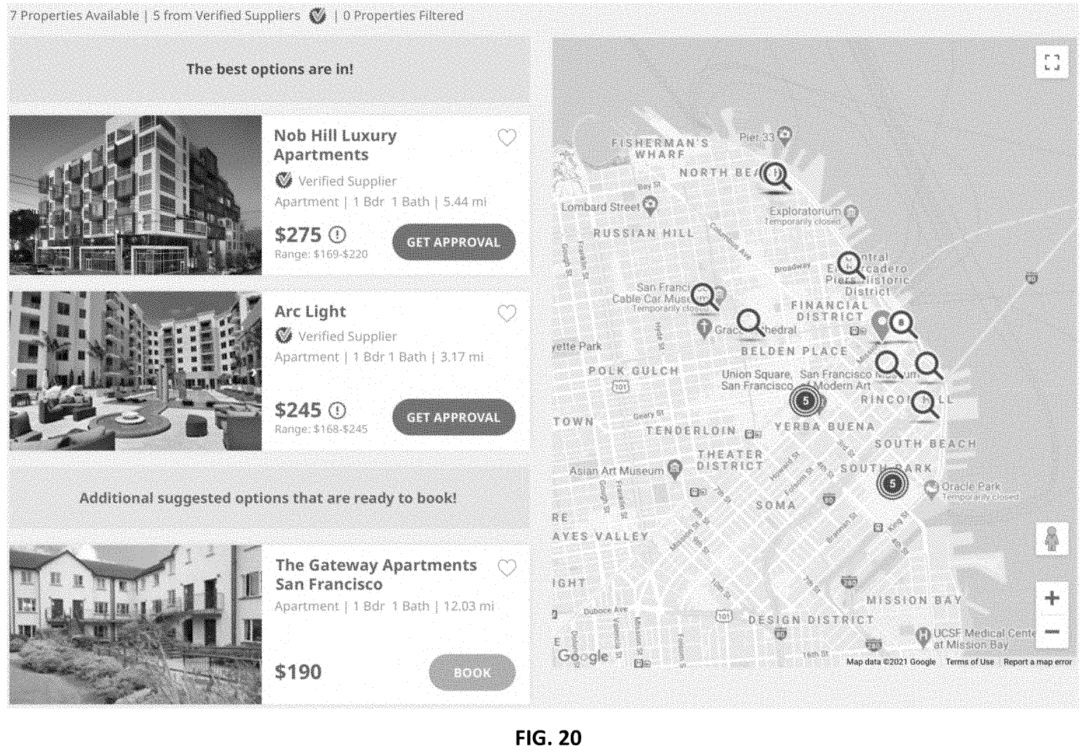

Once the query is complete, system 100 provides a list of available accommodations at 108. This may be presented to the employee in a graphical interface so that the various choices are presented to the employee in a ranked order. A representative employee user interface displaying a list of available accommodations is included as FIG. 20. The prices for each accommodation will also be displayed for review by the employee. At 112, the employee can check off the specific accommodations that most interest them and that are most consistent with the identified factors. The employee can select one or more than one available accommodation from the list.

System 100 will allow the organization to ensure that any accommodations adhere to pre-established policies regarding employee accommodations. These polices may relate to the price of the accommodation, or other factors such as room type, room size, or location. For example, the policy may state that an employee of 5 years can spend no more than $500 a night for a hotel room. Alternatively, the policy may state that a supervisor must pre-approve accommodations in certain metropolitan areas or pre-approve a hotel suite. All such polices will be stored within an accessible from a database. The system may also store data relating to pricing provided by third parties in response to a Request for Proposal.

System 100 may also store certain information regarding the prevailing market rates for accommodations within a prescribed geographic area. For example, system 100 may store information within database 102 reflecting the prevailing rate for a two bedroom apartment in New York City or a single hotel room in Chicago. Thus, supervisors within the organization can set benchmarks that allow employees to book accommodations only when they are within a specified range of the stored, prevailing market rate. For example, the organization can decide that a requested accommodation that is 20% higher than the prevailing market rate will either be denied or require the pre-approval of a supervisor before being booked. In another possible example, a requested accommodation that is only 5% higher than the prevailing market rate for the geographic area may be pre-approved for booking by the employee. System 100 allows these benchmarks to be set and revised as needed.

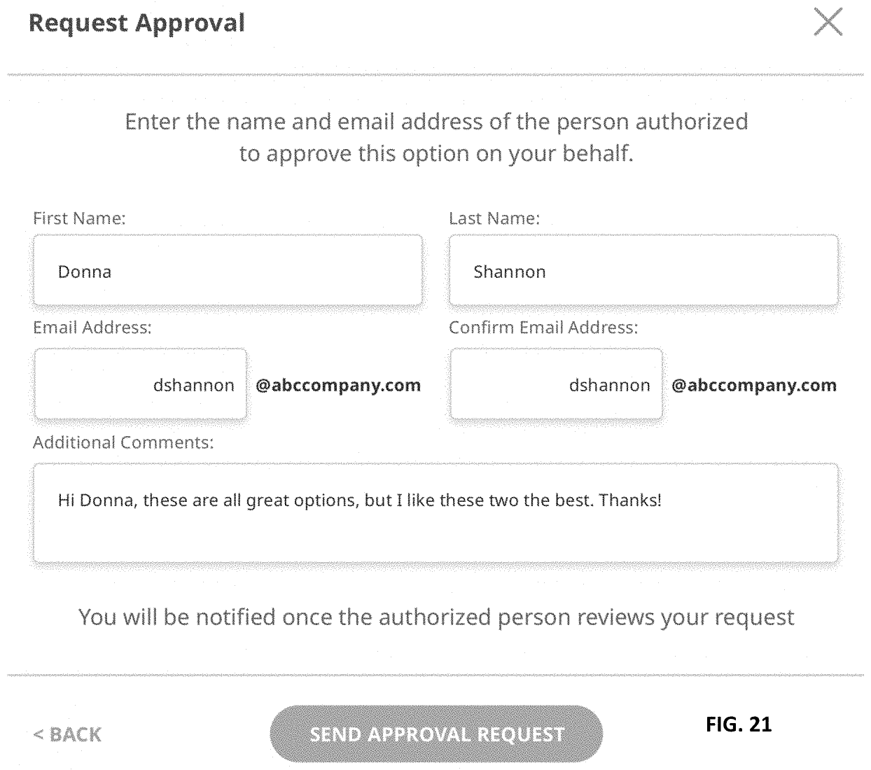

As noted, based upon pre-established company policies or prevailing market rates, the accommodation selected by the employee may be automatically approved by the system at 114. Namely, requests that adhere to the company policy or that are consistent with the prevailing (and benchmarked) market rates will be automatically approved. If such automatic approval is given, the employee is notified of this approval at 124. If the approval is not automatic, the employee will be notified at 116 that a supervisor needs to approve one or more of the selected accommodations. In this regard, the employee may be prompted for the names can email addresses of one or more supervisors. The employee may also select from a drop down list of available supervisors. The graphical user interface for such a prompt is depicted in FIG. 21. The pre-approval or approval request will be managed by a processor associated with database 102.

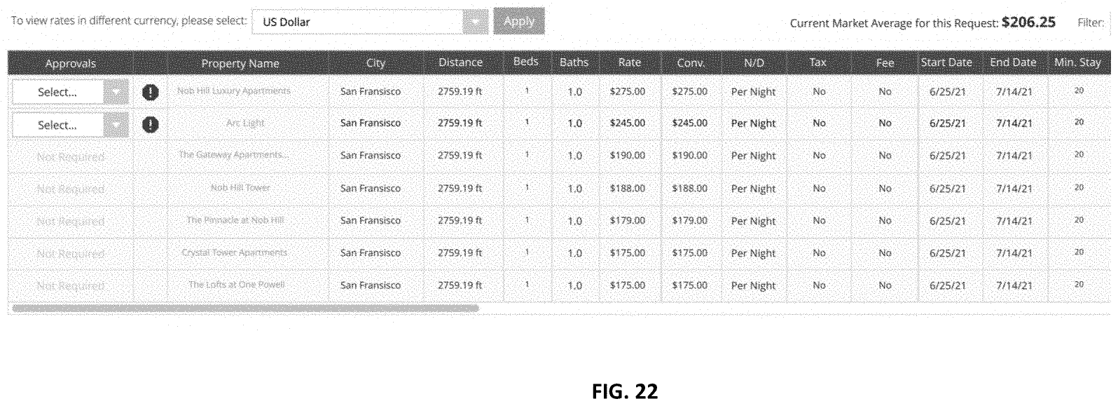

Thereafter, at 118 the supervisor is notified of the request for approval from the employee. The supervisor may also be provided with the factors the employee identified as most important for the accommodation. The system may present the supervisor with a graphical user interface listing all of the pending approvals from various employees. This interface is depicted in FIG. 22. Color coding can be used to reflect any requests that are outside of company policies, known market rates, or any other relevant benchmark set by the organization. The supervisor can then approve or decline the various requests from the dashboard at 122. An employee is thereafter notified of the request being denied (124) or approved (126). These approvals or denials can be sent by SMS messaging, email, voicemail, or via smart phone based applications.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

What is claimed is:

1. A system for managing and approving accommodations requests within an organization, the system being utilized by employees and supervisors within the organization, the system comprising:
a database storing information related to various available accommodations, the available accommodations being indexed according to price, geographic location, and type, the database further storing benchmarks regarding the accommodations, the benchmarks reflecting the organizations pre-established policies regarding the employee's ability to reserve the accommodation;
an employee graphical user interface allowing an employee to query the database to make an accommodations request, the interface allowing the employee to specify the most important factors related to the accommodations request, the employee graphical user interface presenting the employee with a listing of available accommodations based upon the accommodations request and allowing the employee to select the desired accommodations;
a processor for determining whether the accommodations in the listing of available accommodations adhere to the stored benchmarks;
a supervisor graphical user interface listing the accommodations selected by the employee and visually indicating whether the selected accommodations adhere to the stored benchmark, the supervisor graphical user interface allowing the supervisor to approve or decline the accommodations selected by the employee.

2. The system as described in claim 1 wherein the supervisor graphical user interface also displays the factors identified by the employee as being most important for the accommodations request.

3. The system as described in claim 1 wherein the listing of available accommodations are graphically presented to the employee on a map.

4. The system as described in claim 1 wherein the benchmark indicates whether the price for an accommodation is above or below a prevailing market rate by a set percentage.

5. The system as described in claim 1 wherein the benchmark reflects a company policy for the size of the accommodation.

6. The system as described in claim 1 wherein a third party provides rate information for the database.

7. A method for approving requests for accommodations within an organization, the method comprising the following steps:
storing information related to various available accommodations, the available accommodations being indexed according to price, geographic location, and type;
setting and storing benchmarks reflecting the organizations pre-established policies regarding an employee's ability to reserve accommodations;
querying the stored information to make an accommodations request and listing the available accommodations based upon the query;
selecting one or more desired accommodations from the listing of available accommodations;
determining whether accommodations in the listing of available accommodations adhere to the stored benchmarks;
visually indicating to a supervisor the selected accommodations and permitting the supervisor to approve accommodations that do not adhere to the stored benchmark.
